(19) United States
(12) Patent Application Publication
(10) Pub. No.: US 2013/0252856 A1
(43) Pub. Date: Sep. 26, 2013

(54) SYNERGISTIC SURFACTANT COMPOSITIONS FOR UNLOADING FLUIDS FROM OIL AND GAS WELLS

(71) Applicant: Baker Hughes Incorporated, Houston, TX (US)

(72) Inventor: Jiang Yang, Missouri City, TX (US)

(73) Assignee: Baker Hughes Incorporated, Houston, TX (US)

(21) Appl. No.: 13/873,166

(22) Filed: Apr. 29, 2013

Related U.S. Application Data
(63) Continuation-in-part of application No. 11/351,018, filed on Feb. 9, 2006, now abandoned.

(51) Int. Cl. C09K 8/584

(52) U.S. Cl. CPC C09K 8/584
USPC 507/209; 166/309; 585/3; 585/4

(57) ABSTRACT

A method for unloading fluids from an oil and gas well, pipeline or flowline includes using a synergistic combination of an alkyl glucoside and an amphoteric surfactant as a foaming composition. Use of the combination foaming composition improves unloading of formation fluids, particularly production fluids having natural gas condensate and water and therefore increases the rate of production from the oil and gas well.

### CROSS REFERENCE TO RELATED APPLICATIONS

This invention claims priority from U.S. patent application Ser. No. 11/351,018 which was filed on Feb. 9, 2006.

### BACKGROUND OF THE INVENTION

1. Field of the Invention

This invention relates to the field of improving hydrocarbon recovery from hydrocarbon reservoirs. This invention particularly relates to improving the unloading of fluids from oil and gas wells, pipelines and flowlines.

2. Background Art

During the production of hydrocarbon products from oil and gas reservoirs where natural gas is the primary or most desired product, a problem with the accumulation of fluids in the well bore is frequently encountered. These fluids, frequently a combination of water or aqueous brine and hydrocarbons, migrate through the formation toward the well bore along with the gas, but then tend to impede the passage of the gas through the well-bore and associated pipelines and/or flowlines. Flowlines are specialized pipelines running from undersea wells to collection centers.

In some cases these produced fluids, hereinafter referred to as production fluids, flow into the well casing annulus in a process called water coning or water logging. This phenomenon causes a hydrostatic load which subsequently reduces the ability of the well to produce fluids and gas to the surface. The production fluids may also pool in sections of pipelines or flowlines that descend and/or ascend, often in response to changes in terrain, rather than maintain a horizontal or vertical flow path, thereby inhibiting flow of gas condensates and gas in those locations. With time the impediment to flow tends to increase, increasing pressure on the impediment. This pressure is undesirable because it may cause the gas to suddenly “surge”, i.e., explosively break through the impeding fluids, either in the well-bore or in an associated flowline or pipeline.

A conventional method of decreasing the impediment resulting from the production fluids is to inject a surfactant downhole into the area of the production fluids. The surfactant serves to “unload” the production fluid, i.e., to remove the production fluid by causing it to foam. The production of foam bubbles effectively and dramatically increases the surface area and reduces the surface tension and density of the production fluid, thus enabling portions thereof to more easily move through the well bore to the surface. The production fluids are moved or carried along through the well-bore, pipeline or flowline with the gas to a point at which the gas can be separated from the water and hydrocarbons. Thus, the likelihood of a surge is reduced, and gas recovery may be increased.

It would be desirable in the art of producing hydrocarbons from oil and gas bearing formations to have additional methods and means of increasing and improving liquid unloading in oil and gas wells, pipelines and flowlines.

### SUMMARY OF THE INVENTION

An object of the invention is to provide a foaming composition which may be effectively used in oil and gas wells, pipelines and flowlines.

Another object of the invention is to provide a foaming composition that improves the unloading of production fluids from oil and gas wells, pipelines and flowlines.

In carrying out these and other objects of the invention, there is provided, in one aspect, a method for unloading a production fluid comprising injecting a foaming composition into a production fluid. The foaming composition is a mixture comprising an alkyl glucoside and an amphoteric surfactant.

In another aspect there is provided a composition suitable to foam a production fluid. This composition comprises a mixture of an alkyl glucoside and an amphoteric surfactant.

### DETAILED DESCRIPTION OF THE INVENTION

A key aspect in the practice of the present method is use of a synergistic combination of surfactants as a foaming composition. It has unexpectedly been found that this combination enables a high degree of foaming and, therefore, increased unloading of production fluids from oil and gas wells, pipelines and flowlines, than would use of either of the constituents alone.

Oil and gas wells will, almost without exception, produce at least a small amount of at least three materials. One of these is natural gas which consists primarily of methane and ethane, but also propane, butane, and nitrogen as well as usually trace amounts of other naturally occurring gasses. The second is crude oil which generally consists of aliphatic and/or aromatic hydrocarbons, usually distinguished from natural gas as being a liquid at ambient temperature and pressure. Crude oil also will include some comparatively high molecular weight compounds such as paraffins and asphaltenes, which are typically dissolved in the lower molecular weight hydrocarbons. The third component is water and aqueous solutions of salts and other water soluble materials, often referred to as brine.

The term “gas well” is sometimes used to describe an oil and gas well that either: 1) produces almost no crude oil or almost no crude oil or brine; or 2) produces too little crude oil to justify the infrastructure necessary to market the crude oil. Similarly, the term oil well is sometimes used to describe an oil and gas well that produces very little natural gas or else is in a region where there is no market for natural gas. In such a situation, the natural gas may often be reinjected into the reservoir in order to maintain the lift energy of the formation.

In one embodiment, the invention is used with a gas well. The high degree of foaming produced using the foaming composition of the invention facilitates the production of production fluid having a significant amount of light hydrocarbon products, especially natural gas condensates also referred to in the art as condensate. As used herein, the term “light hydrocarbon(s)” is distinguished from “heavy hydrocarbons”, which refers to those hydrocarbons that are liquid under ambient temperatures and pressures such as crude oil.

In gas well embodiments, the foaming compositions serve to foam the production fluid, in part to produce it at the surface for sale, but often primarily to move the production fluid out of the way so that it does not impede the flow of natural gas from the oil and gas well.

In another embodiment, the invention is used to increase the production of an oil well. In an oil well, the production fluids often have a substantial proportion of heavy hydrocarbons such as crude oil. The foaming compositions of the invention may be employed with the use of an injected gas such as nitrogen or carbon dioxide. In this and similar embodiments, the foaming composition of the invention serves to foam the production fluid to unload the heavy hydrocarbons which are the products of greatest interest in an oil well. By foaming the heavy hydrocarbons, the heavy hydrocarbons are reduced in viscosity and thus more easily brought to the surface. The invention may also be useful in removing an excess of brine that may be acting as an impediment to hydrocarbon flow from the reservoir and to the surface.

In the practice of the invention, a foaming composition is injected or otherwise introduced into a production fluid. Ideally, the production fluid is then agitated in the presence of a gas. Often, the gas itself is the source of the agitation. Sometimes, the gas and the agitation are due to the energetic production of natural gas from the oil and gas reservoir. In some embodiments, the gas, the agitation and even both the gas and agitation are introduced downhole by the well operator. The foaming composition of the present invention may be used in any way known to those of ordinary skill in the art of producing oil and gas to be useful in foaming operations.

In regard to pipelines and flow lines, where the ascending and descending of a the pipeline or flowline creates “valleys” that allow for, in the case of natural gas, an accumulation of any fluid, the foaming composition may be used to foam and thereby unload the liquid from the valley to allow for the unimpeded flow of gas. Even in a pipeline or flow line transporting crude oil, the accumulation of production fluids that are primarily brine may be an impediment to the flow of production fluid that is primarily crude oil. In such cases the invention may also be used to foam and thereby sweep the production fluid out of the way to allow for improved flow of the production fluid that is primarily crude oil.

The first component of the foaming composition of the invention is an alkyl glucoside, which operates as a nonionic surfactant. In certain embodiments the alkyl glucoside has from about 1 to about 5 glucoside units, and an alkyl chain length of from about 8 to about 18. Such an alkyl glucoside includes, in one embodiment, polyglucosides. Non-limiting examples of polyglucosides include alkyl polyglucosides based on C₈-C₁₈ fatty alcohols, including capryl glucoside, decyl glucoside, coco-glucoside, and lauryl glucoside.

The second component of the foaming composition of the invention is an amphoteric surfactant. Amphoteric surfactants are by definition surfactants that have characteristics of both an acid and a base, and are therefore capable of reacting as either, i.e., of accepting or donating protons. Such surfactants may be alternatively characterized as being zwitterionic, meaning that in solution the molecules form dipolar ions capable of carrying both a positive and a negative charge simultaneously. Non-limiting examples include, but are not necessarily limited to, alkyl betaines, alkylamidopropyl betaines, alkylampho acetates, alkylampho propionates, alkyl hydroxysultaines, alkylamidopropyl hydroxysultaines, combinations thereof, and the like. Carbon chain length for these amphoteric/zwitterionic surfactants may range, in some non-limiting embodiments, from about C₈ to about C₁₈.

Proportions of the two foaming composition components described hereinabove may be in a range of alkyl glucoside to amphoteric surfactant of from about 99/1 to about 1/99, on a volume/volume basis, and in some non-limiting embodiments from about 90/10 to about 10/90. In other non-limiting embodiments volume/volume proportions may range from about 60/40 to about 40/60.

While levels of usage in the well-bore, pipeline or flowline may vary according to a variety of field conditions, it is estimated that, in some non-limiting embodiments, the foaming composition may be used in an amount ranging from about 10 ppm to about 50,000 ppm, based on the estimated amount of formation fluid to be foamed in the well bore, pipeline or flowline. In other non-limiting embodiments, the foaming composition may be used in an amount ranging from about 100 ppm to about 20,000 ppm.

In one embodiment, the foaming composition may be introduced into an oil and gas well through continuous injection of the foaming composition through capillary tubing. The composition may alternatively be batched through the tubing, by any means known to those of ordinary skill in the art, for example by using either the procedure known as “batch and fall”, or by tubing displacement. Any means known to be useful for introducing a foaming composition downhole or into a pipeline or flowline to be useful may be used with the invention.

Batch injection to an impeded pipeline or flowline may also be employed; however, efficient unloading in the well-bore, followed by separation of the unloaded fluids at the surface, will in many cases reduce or eliminate the need for additional foaming compositions for improving unloading at remote pipeline and flowline sites.

The invention having been generally described hereinabove, those skilled in the art will appreciate that various modifications may be made without straying outside of the scope of the invention, as embodied in the claims appended hereto. Many potential embodiments can be envisioned by those skilled in the art, including, for example, application to a wide variety of surfactant component selections and drill site conditions, involving a wide variety of types of equipment and methods of introduction of the foaming composition.

The following examples are provided merely to further illustrate the invention for the purpose of increasing the reader's overall understanding of it. As such they represent merely additional potential embodiments of the invention.

### EXAMPLE 1

In a laboratory experiment, three brine/hydrocarbon mixtures, having a volume ratio of 70/30, are successively placed in a 5×75 cm column for tests of three different foaming compositions. The brine composition in each case is 4 g/l Ca₂Cl₂.2H₂O, 1.86 g/l MgCl₂.6H₂O, and 94 g/l NaCl, and the model hydrocarbon is kerosene. Foam is generated by introducing a foaming composition, as shown in Table 1, in an amount of about 10,000 ppm in 100 ml of the brine/oil liquid. Nitrogen gas is introduced into the column through a fret, at a gas flow rate of 12 ft³/hr. In each case foam rise and carryover of liquid to a container is measured, in a simulation of the gas unloading process that is expected to occur downhole. It is seen that neither the alkyl glucoside nor the amphoteric material, the amido betaine, alone unloads any significant amount of liquid or foam, but that the combination thereof is synergistic and unloads a significant quantity of liquid and foam.

TABLE 1

| Foaming | | | |
|---|---|---|---|
| composition | | | |
| Components | Formula 1* | Formula 2* | Formula 3 |
| Decyl glucoside- | | 21.4% | 10.7% |
| 70% | | | |
| Capryl/capramido | 40.6% | | 20.3% |
| betaine-37% | | | |
| H₂O | 59.4% | 78.6% | 69% |
| Unloaded | 0 g | 0 g | 9 g |
| liquid/foam | | | |

*Not an example of the invention.

### EXAMPLE 2

The same series of surfactant foaming compositions as in Example 1 are tested in the presence of field gas condensate from the Mobile Bay Gas Field. The gas condensate is used in place of the kerosene shown in Example 1. The composition of the brine is 93 g/l Ca₂Cl₂.2H₂O, 20 g/l MgCl₂.6H₂O, and 118 g/l NaCl. Proportions and procedures are otherwise as shown in Example 1. The unloading results may be seen in Table 2.

TABLE 2

| Foaming | | | |
|---|---|---|---|
| composition | | | |
| Components | Formula 4* | Formula 5* | Formula 6 |
| Decyl glucoside- | | 21.4% | 10.7% |
| 70% | | | |
| Capryl/capramido | 40.6% | | 20.3% |
| betaine-37% | | | |
| H₂O | 59.4% | 78.6% | 69% |
| Unloaded | 20 g | 35 g | 60 g |
| liquid/foam | | | |

*Not an example of the invention

It is seen that the combination material, Formula 6, shows significantly higher unloading than is shown by either the alkyl glucoside or the amido betaine alone.

What is claimed is:

1. A method for foaming production fluid comprising injecting a foaming composition comprising a mixture of an alkyl glucoside and an amphoteric surfactant into a production fluid wherein:
the mixture of alkyl glucoside and the amphoteric surfactant produce materially more foam than the alkyl glucoside and the amphoteric surfactant do alone; and
the alkyl glucoside has from about 1 to about 5 glucoside units, and an alkyl chain length of from about 8 to about 18 carbons.

2. The method of claim 1 wherein the alkyl glucoside is selected from the group consisting of decyl glucoside, octyl glucoside, dodecyl glucoside and combinations thereof.

3. The method of claim 1 wherein the amphoteric surfactant has an alkyl substituent having from about 8 to about 18 carbons.

4. The method of claim 3 wherein the amphoteric surfactant is selected from the group consisting of alkyl betaines, alkylamidopropyl betaines, alkylampho acetates, alkylampho propionates, alkyl hydroxysultaines, alkylamidopropyl hydroxysultaines, and combinations thereof.

5. The method of claim 1 wherein the production fluid is present in an oil and gas well, a pipeline, or a flowline.

6. The method of claim 1 wherein the production fluid includes natural gas condensate.

7. A composition, suitable for foaming a production fluid comprising an alkyl glucoside and an amphoteric surfactant.

8. The composition of claim 7 wherein the alkyl glucoside has from about 1 to about 5 glucoside units, and an alkyl chain length of from about 8 to about 18 carbons.

9. The composition of claim 8 wherein the alkyl glucoside is selected from the group consisting of decyl glucoside, octyl glucoside, dodecyl glucoside and combinations thereof.

10. The composition of claim 8 wherein the amphoteric surfactant has an alkyl substituent having from about 8 to about 18 carbons.

11. The composition of claim 10 wherein the amphoteric surfactant is selected from the group consisting of alkyl betaines, alkylamidopropyl betaines, alkylampho acetates, alkylampho propionates, alkyl hydroxysultaine, alkylamido-propyl hydroxysultaine, and combinations thereof.

12. A method for unloading production fluid from an oil and gas well comprising injecting a foaming composition comprising a mixture of alkyl glucoside and an amphoteric surfactant downhole into the production fluid wherein:
the mixture of alkyl glucoside and the amphoteric surfactant produce materially more foam than the alkyl glucoside and the amphoteric surfactant do alone; and
the alkyl glucoside has from about 1 to about 5 glucoside units, and an alkyl chain length of from about 8 to about 18 carbons.

13. The method of claim 12 wherein the alkyl glucoside is selected from the group consisting of decyl glucoside, octyl glucoside, dodecyl glucoside and combinations thereof.

14. The method of claim 12 wherein the amphoteric surfactant has an alkyl substituent having from about 8 to about 18 carbons.

15. The method of claim 14 wherein the amphoteric surfactant is selected from the group consisting of alkyl betaines, alkylamidopropyl betaines, alkylampho acetates, alkylampho propionates, alkyl hydroxysultaines, alkylamidopropyl hydroxysultaines, and combinations thereof.

16. A method for unloading production fluid from a pipeline or a flowline comprising injecting a foaming composition comprising a mixture of alkyl glucoside and an amphoteric surfactant into production fluid in the pipeline or flowline wherein the mixture of alkyl glucoside and the amphoteric surfactant produce materially more foam than the alkyl glucoside and the amphoteric surfactant do alone; and
the alkyl glucoside has from about 1 to about 5 glucoside units, and an alkyl chain length of from about 8 to about 18 carbons.

17. The method of claim 16 wherein the alkyl glucoside is selected from the group consisting of decyl glucoside, octyl glucoside, dodecyl glucoside and combinations thereof.

18. The method of claim 16 wherein the amphoteric surfactant has an alkyl substituent having from about 8 to about 18 carbons.

19. The method of claim 16 wherein the amphoteric surfactant is selected from the group consisting of alkyl betaines, alkylamidopropyl betaines, alkylampho acetates, alkylampho propionates, alkyl hydroxysultaines, alkylamidopropyl hydroxysultaines, and combinations thereof.
